(19) United States
(12) Patent Application Publication
(10) Pub. No.: US 2026/0062899 A1
(43) Pub. Date: Mar. 5, 2026

(54) FAUCET INCLUDING UNDER DECK VALVE CARTRIDGE

(71) Applicant: Delta Faucet Company, Indianapolis, IN (US)

(72) Inventors: Yilin Tang, Carmel, IN (US); Brian Wayne Johnson, Muncie, IN (US)

(21) Appl. No.: 19/295,058

(22) Filed: Aug. 8, 2025

Related U.S. Application Data
(60) Provisional application No. 63/689,151, filed on Aug. 30, 2024.

(51) Int. Cl. E03C 1/04; F16K 11/00

(52) U.S. Cl. CPC E03C 1/0401; F16K 19/006; F16K 2200/501

(57) ABSTRACT

A faucet assembly is mounted to a mounting deck having a passageway extending from a first surface of the mounting deck to a second surface of the mounting deck. The faucet assembly includes a spout emitting a fluid therefrom. A valve cartridge is mounted below the mounting deck. The valve cartridge is connected to a source of the fluid and provides the fluid to the spout. The valve cartridge has a plurality of rotational positions. A parameter of the fluid emitted by the spout is dependent upon a current rotational position of the valve cartridge. A lower wheel is attached to the valve cartridge such that rotation of the valve cartridge follows rotation of the lower wheel. A rotatable, manually-operable valve controller is mounted above the mounting deck. An upper wheel is attached to the valve controller such that rotation of the upper wheel follows rotation of the valve controller. A transmission element extends through the passageway of the mounting deck. The transmission element is carried by the lower wheel and by the upper wheel such that rotation of the upper wheel causes movement of the transmission element, and the movement of the transmission element causes rotation of the lower wheel.

### CROSS-REFERENCE TO RELATED APPLICATION

The present application claims priority to U.S. Provisional Patent Application Ser. No. 63/689,151, filed Aug. 30, 2024, the disclosure of which is expressly incorporated herein by reference.

### BACKGROUND AND SUMMARY OF THE INVENTION

The present invention relates generally to faucets. Specifically, the present disclosure relates to a faucet having a reduced profile.

On a conventional 90-degree single handle bathroom faucet, the mixing valve cartridge sits on a side extension or boss of the faucet body or spout. To mix hot and cold water, and provide sufficient flow rate, the valve cartridge typically has a diameter of at least 22 millimeters (mm). This size valve cartridge requires a relatively large side boss of the faucet body, often limiting aesthetic design options.

The conventional large valve cartridge design includes a manifold that may limit the assembly method. In many faucets, it is difficult to feed the manifold through the 90-degree body, and thus assembly must be done manually without automation.

The present disclosure may enable the valve cartridge to be mounted under the sink deck rather than on the side boss of the faucet body. Thus, there may be fewer constraints on valve cartridge size with the cartridge being mounted under the sink deck.

The present disclosure may provide different illustrative embodiments for transferring or transmitting above-deck handle movement to under-deck cartridge movement. In one illustrative embodiment, a belt and a set of gears may provide the transmission. In another illustrative embodiment, a rack and pinion may provide the transmission.

According to an illustrative embodiment of the present disclosure, a faucet assembly is mounted to a mounting deck having a passageway extending from a first surface of the mounting deck to a second surface of the mounting deck. The faucet assembly includes a spout emitting a fluid therefrom. A valve cartridge is mounted below the mounting deck. The valve cartridge is connected to a source of the fluid and provides the fluid to the spout. The valve cartridge has a plurality of rotational positions. A parameter of the fluid emitted by the spout is dependent upon a current rotational position of the valve cartridge. A lower wheel is attached to the valve cartridge such that rotation of the valve cartridge follows rotation of the lower wheel. A rotatable, manually-operable valve controller is mounted above the mounting deck. An upper wheel is attached to the valve controller such that rotation of the upper wheel follows rotation of the valve controller. A belt extends through the passageway of the mounting deck. The belt is carried by the lower wheel and by the upper wheel such that rotation of the upper wheel causes rotation of the belt, and the rotation of the belt causes rotation of the lower wheel.

According to another illustrative embodiment of the present disclosure, a faucet assembly includes a spout emitting a fluid therefrom. A valve cartridge is connected to a source of the fluid and provides the fluid to the spout. The valve cartridge has a plurality of rotational positions. A parameter of the fluid emitted by the spout is dependent upon a current rotational position of the valve cartridge. A first wheel is attached to the valve cartridge such that rotation of the valve cartridge follows rotation of the first wheel. A second wheel is attached to a rotatable, manually-operable valve controller such that rotation of the second wheel follows rotation of the valve controller. A power transmission element engages the first wheel and by the second wheel such that rotation of the second wheel causes movement of the power transmission element, and the movement of the power transmission element causes rotation of the first wheel.

According to yet another illustrative embodiment of the present disclosure, a faucet assembly is mounted to a mounting deck having a passageway extending from a first surface of the mounting deck to a second surface of the mounting deck. The faucet assembly includes a spout emitting a fluid therefrom. A valve cartridge is mounted below the mounting deck. The valve cartridge is connected to a source of the fluid and provides the fluid to the spout. The valve cartridge has a plurality of rotational positions. At least one parameter of the fluid emitted by the spout is dependent upon a current rotational position of the valve cartridge. A lower pinion is attached to the valve cartridge such that rotation of the valve cartridge follows rotation of the lower pinion. The lower pinion has a plurality of teeth. A rotatable, manually-operable valve controller is mounted above the mounting deck. An upper pinion is attached to the valve controller such that rotation of the upper pinion follows rotation of the valve controller. The upper pinion has a plurality of teeth. A rack extends through the passageway of the mounting deck. The rack has an upper set of teeth and a lower set of teeth. The upper set of teeth is intermeshed with the teeth of the upper pinion. The lower set of teeth is intermeshed with the teeth of the lower pinion. Rotation of the upper pinion causes vertical movement of the rack, and the vertical movement of the rack causes rotation of the lower pinion.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an upper perspective view of an illustrative faucet assembly of the present disclosure mounted to a sink and coupled to a fluid source for operation.

FIG. 2 is a lower perspective view of the faucet assembly and sink of FIG. 1.

FIG. 3 is a rear elevational view of the faucet assembly and sink of FIG. 1.

FIG. 4 is a side elevational view of the faucet assembly and sink of FIG. 1.

FIG. 5 is an upper perspective view of the faucet assembly of FIG. 1.

FIG. 6 is an upper perspective view of the belt and gear assembly and the valve cartridge of the faucet assembly of FIG. 1.

FIG. 7 is a lower perspective view of the belt and gear assembly and the valve cartridge of the faucet assembly of FIG. 1.

FIG. 8 is an exploded perspective view of the belt and gear assembly and the valve cartridge of the faucet assembly of FIG. 1.

FIG. 9 is an exploded perspective view of the upper end of the belt and gear assembly of the faucet assembly of FIG. 1.

FIG. 10 is an exploded perspective view of the lower end of the belt and gear assembly of the faucet assembly of FIG. 1.

FIG. 11 is a perspective cross-sectional view of the belt and gear assembly and the valve cartridge of the faucet assembly of FIG. 1.

FIG. 12 is a perspective cross-sectional view of the valve controller and the upper end of the belt and gear assembly of the faucet assembly of FIG. 1.

FIG. 13 is a perspective cross-sectional view of the cartridge of the faucet assembly of FIG. 1.

FIG. 14 is a side cross-sectional view of the belt and gear assembly of the faucet assembly of FIG. 1.

FIG. 15 is a side cross-sectional view of the upper end of the belt and gear assembly of the faucet assembly of FIG. 1.

FIG. 16 is a side cross-sectional view of the lower end of the belt and gear assembly of the faucet assembly of FIG. 1.

FIG. 17 is a perspective view of the lower end of the belt and gear assembly, and the core of the valve cartridge of the faucet assembly of FIG. 1.

FIG. 18 is a perspective view of a spindle coupled to the upper end of the belt of the faucet assembly of FIG. 1.

FIG. 19 is a partially exploded perspective view of the belt and gear assembly of the faucet assembly of FIG. 1.

FIG. 20 is a perspective cross-sectional view of a middle portion of the belt and gear assembly of the faucet assembly of FIG. 1.

FIG. 21 is an upper perspective view of another illustrative faucet assembly of the present disclosure.

FIG. 22 is an exploded perspective view of the rack and pinion assembly and the valve cartridge of the faucet assembly of FIG. 21.

FIG. 23 is a side cross-sectional view of the rack and pinion assembly of the faucet assembly of FIG. 21.

FIG. 24 is a side cross-sectional view of the upper end of the rack and pinion assembly of the faucet assembly of FIG. 21.

FIG. 25 is a side cross-sectional view of the lower end of the rack and pinion assembly of the faucet assembly of FIG. 21.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

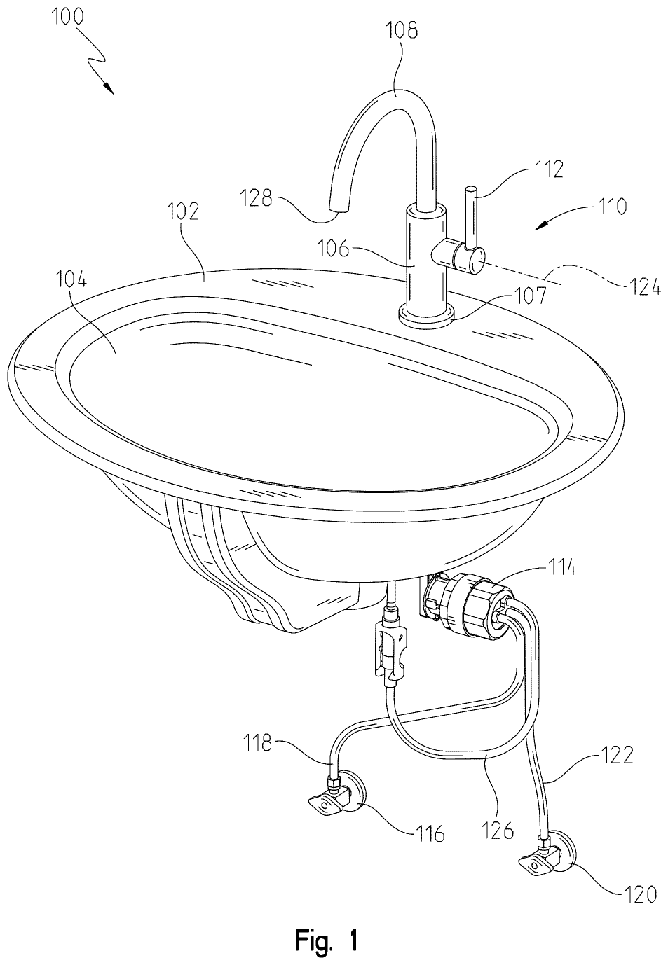

Referring initially to FIG. 1, an illustrative faucet assembly 100 of the present disclosure is illustrated. The faucet assembly 100 is mounted to a mounting deck 102, illustratively a sink deck, adjacent to a basin 104. The illustrative faucet assembly 100 includes a faucet hub 106 supported above a base or escutcheon 107, a spout 108 supported above the hub 106, and a valve assembly 110 supported by the hub 106. Illustratively, valve assembly 110 includes a handle 112 rotatably supported above the escutcheon 107 so that the handle 112 is configured to rotate relative to the hub 106 and the mounting deck 102 when mounted. In some illustrative embodiments, the spout 108 may also be rotatable relative to the hub 106 and the mounting deck 102.

The escutcheon 107 may engage a top side of mounting deck 102, and a mounting nut 109 and cooperating mounting plate or washer 111 may engage a bottom side of mounting deck 102. The mounting deck 102 is clamped between escutcheon 107 and nut 109. The nut 109 threadably engages with a threaded mounting shank 113. Illustrative valve assembly 110 also includes a valve cartridge 114 that is disposed below mounting deck 102. Valve cartridge 114 is manually operable via handle 112 via a transmission mechanism that is described in detail below.

Referring further to FIG. 1, the valve cartridge 114 is fluidly coupled to a first fluid source 116, illustratively a hot water source such as a hot water valve stop. A first source pipe 118 (e.g., a flexible tube formed of a polymer, such as cross-linked polyethylene (PEX)) fluidly couples the first fluid source 116 to the valve cartridge 114. The valve cartridge 114 is also operably coupled to a second fluid source 120, illustratively a cold water source such as a cold water valve stop. A second source pipe 122 (e.g., a flexible tube formed of a polymer, such as cross-linked polyethylene (PEX)) fluidly couples the second fluid source 120 to the valve cartridge 114. As further detailed herein, the valve cartridge 114 is illustratively of conventional design as including a rotatable valve member (e.g., valve disc or plate) (not shown) to control the rate and/or temperature of water flowing through the valve cartridge 114.

More particularly, the faucet assembly 100 is arranged so that actuation of the valve cartridge 114 via rotation of the handle 112 about axis 124 permits fluid flow from the first fluid source 116 and from the second fluid source 120 through valve cartridge 114 and out of an outlet pipe 126 (e.g., a flexible tube formed of a polymer, such as cross-linked polyethylene (PEX)). Outlet pipe 126 fluidly couples the valve cartridge 114 to the spout 108 to permit fluid flow through an outlet 128 of the spout 108. The outlet 128 may be defined by a conventional aerator.

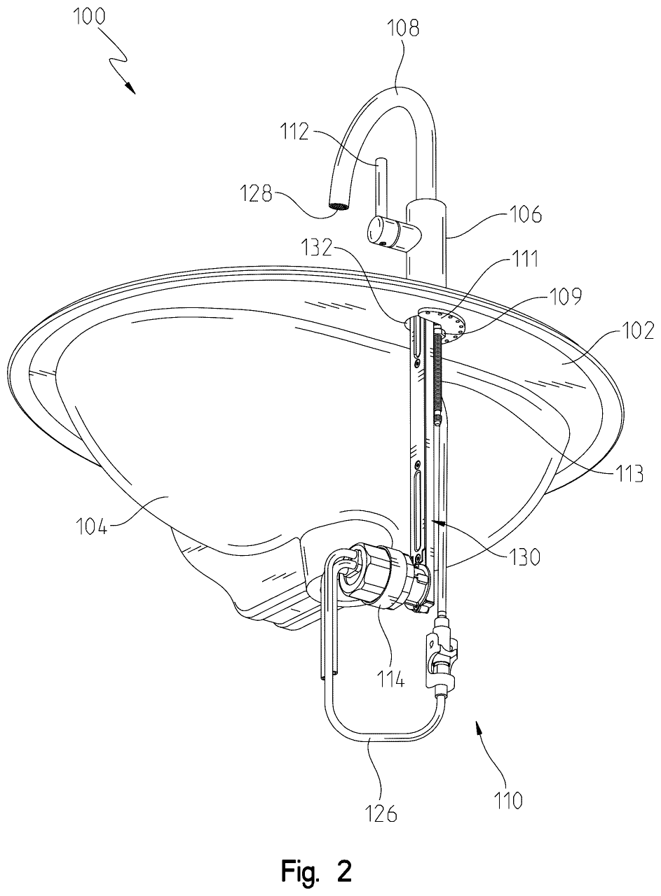

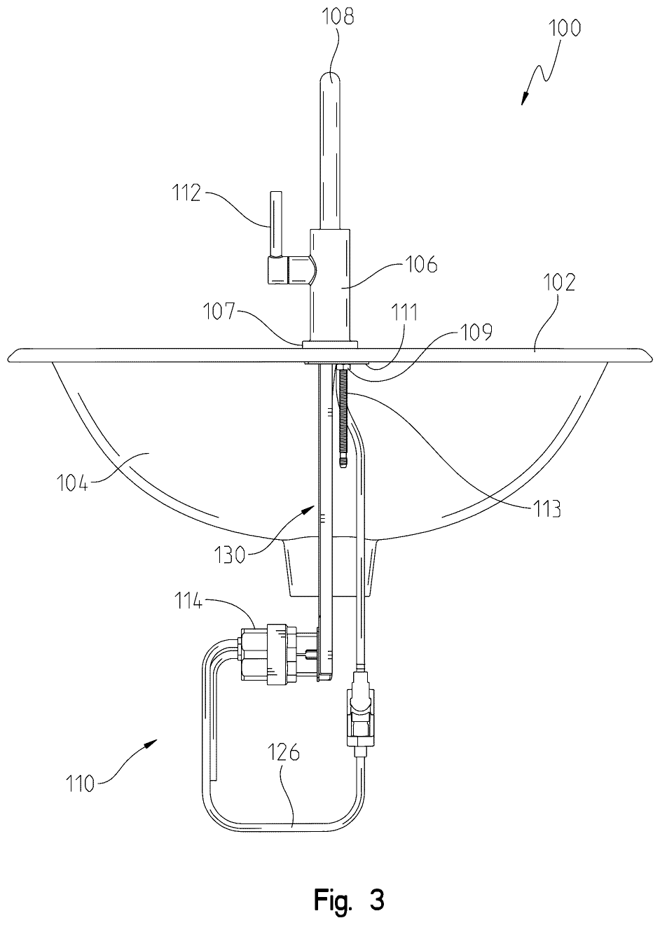

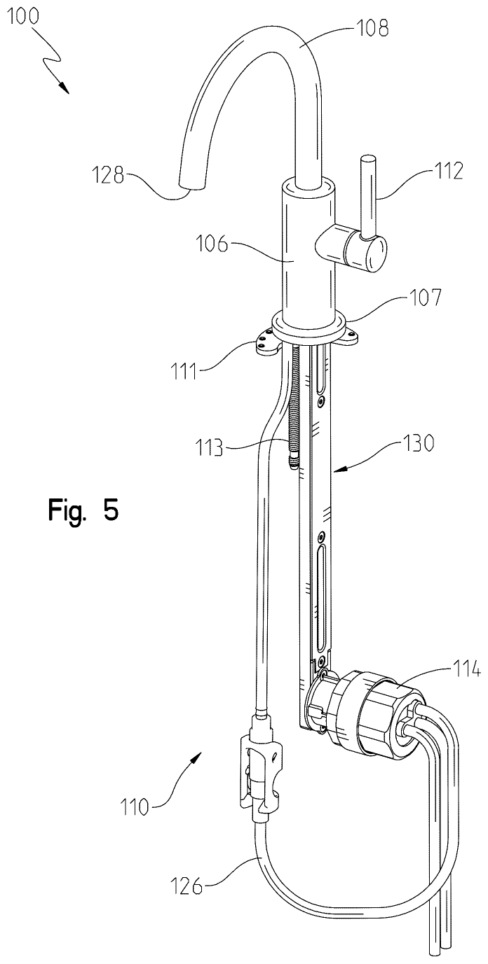

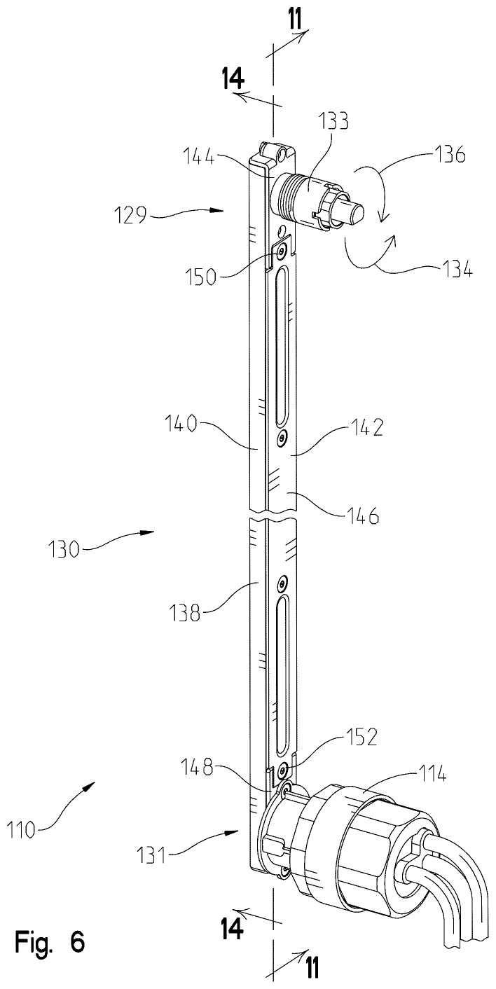

Referring further to FIG. 1 and to FIGS. 2-6, the illustrative valve assembly 110 includes a belt and gear assembly 130 that is operably coupled to handle 112 at its upper end 129 (FIG. 6), and that is coupled to valve cartridge 114 at its lower end 131 (FIG. 6). Belt and gear assembly 130 can extend through a through-hole 132 or other type of passageway or pass-through in mounting deck 102 (FIG. 2).

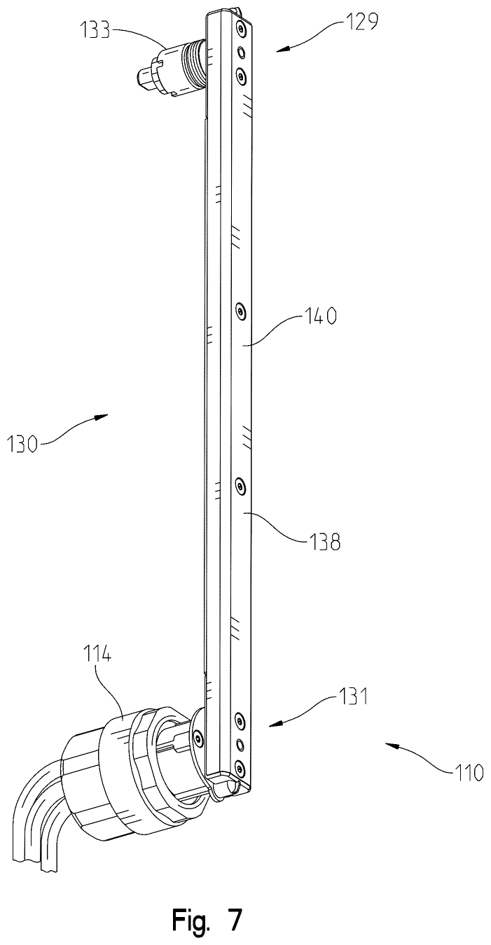

As further shown in FIGS. 6 and 7, lower end 131 of belt and gear assembly 130 is coupled to valve cartridge 114. Upper end 129 of belt and gear assembly 130 is coupled to a valve cartridge controller 133, which, in turn, is coupled to handle 112.

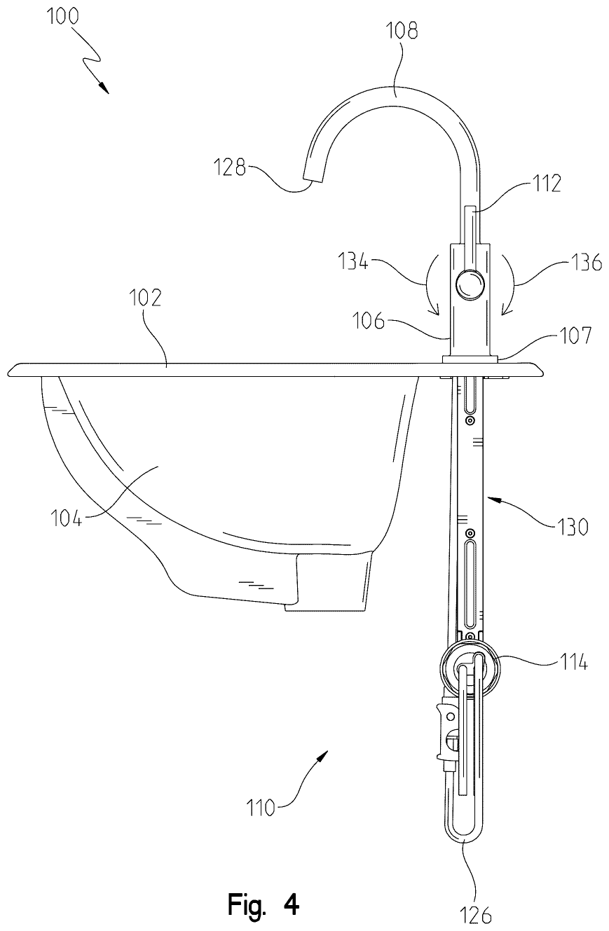

During use, as handle 112 is manually rotated in counterclockwise direction 134 (FIG. 4), controller 133 also rotates in counterclockwise direction 134 (FIG. 6). Similarly, as handle 112 is manually rotated in clockwise direction 136 (FIG. 4), controller 133 also rotates in clockwise direction 136 (FIG. 6).

Illustrative belt and gear assembly 130 includes a housing 138 having a channel 140 and a channel cover 142. Cover 142 includes a top section 144, a middle section 146 and a bottom section 148. Middle section 146 may be fastened to top section 144 by a screw 150, and may be fastened to bottom section 148 by another screw 152.

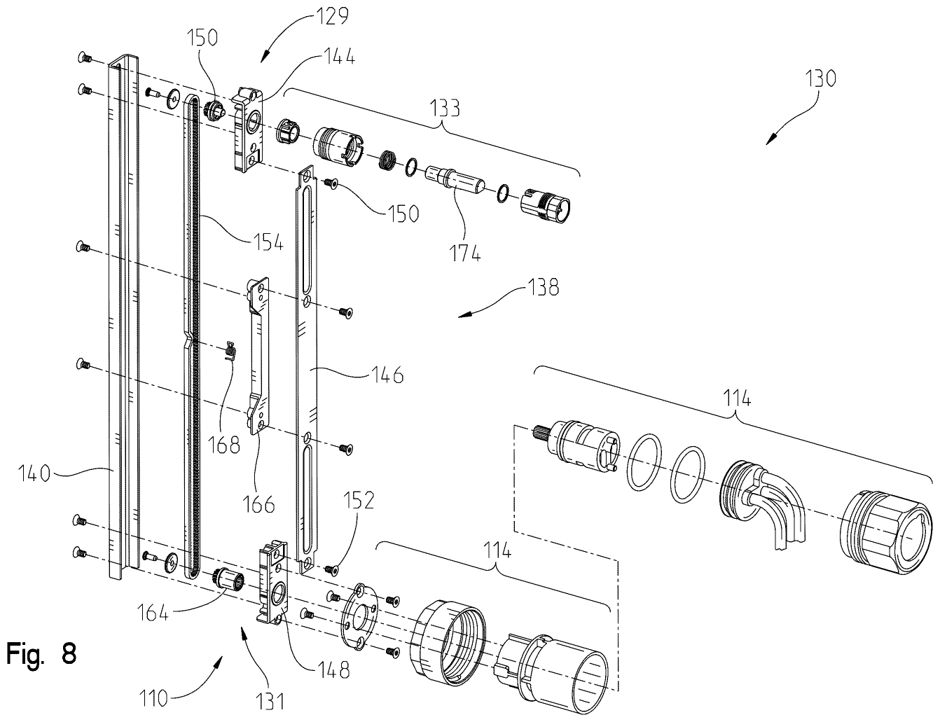

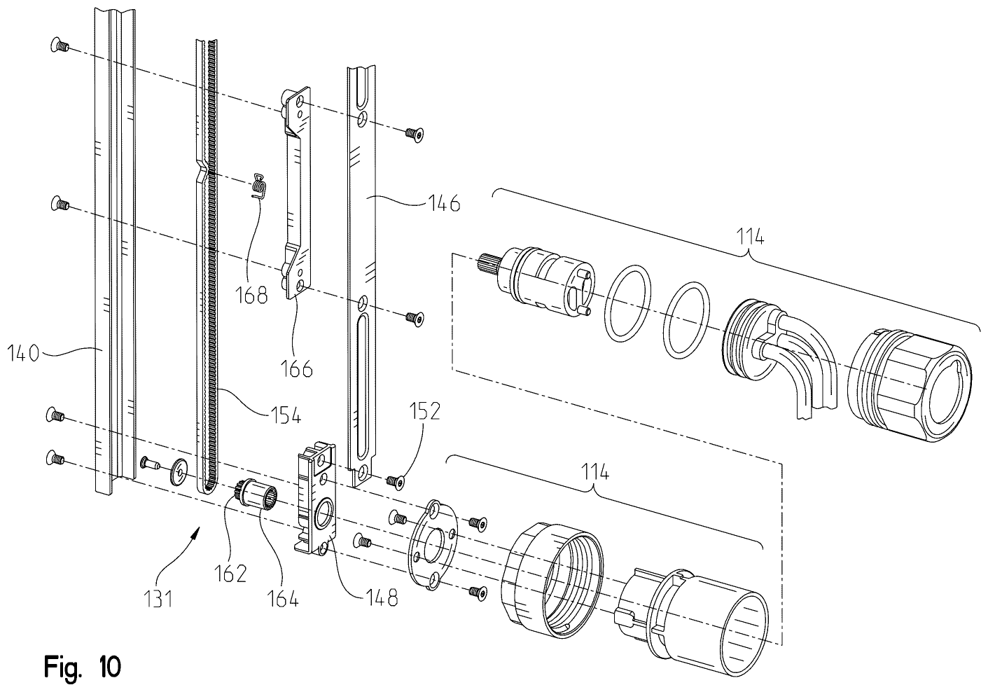

As shown in FIGS. 8-10, illustrative belt and gear assembly 130 further includes a flexible belt 154 having interior teeth 156 that mesh with exterior teeth 158 of an upper wheel in the form of an upper gear coupler 160. Interior teeth 156 of flexible belt 154 also mesh with exterior teeth 162 of a lower wheel in the form of a lower gear coupler 164. A spacer plate 166 may be disposed in channel 140 in order to maintain clearance between belt 154 and channel 140 and between belt 154 and middle section 146 of cover 142. A tensioner 168 maintains a desired level of tension in belt 154.

During operation, a human user may rotate handle 112 in counterclockwise direction 134, which causes controller 133 and upper gear coupler 160 to also rotate in counterclockwise direction 134. The intermeshing of teeth 158 of upper gear coupler 160 with teeth 156 of belt 154 causes the rotation of upper gear coupler 160 to result in a corresponding rotation of belt 154. Further, the intermeshing of teeth 156 of belt 154 with teeth 162 of lower gear coupler 164 causes the rotation of belt 154 to result in a corresponding rotation of lower gear coupler 164. Further still, the rotation of lower gear coupler 164 causes a corresponding rotation of valve cartridge 114.

Rotation of valve cartridge 114 may cause water to flow to spout 108 in the same manner as rotation of a conventional valve cartridge that is disposed above the sink deck would. In a particular embodiment, rotation of handle 112 in counterclockwise direction 134 initially causes only cold water to flow through spout 108 at an increasing rate until a maximum flow rate is reached. Further rotation of handle 112 after the maximum flow rate of cold water is reached results in the cold water gradually being replaced by hot water until the flow is comprised of hot water only. Rotation of handle 112 back in the opposite direction 136 may reverse the above-described progression, resulting in the hot water gradually being replaced by cold water, and then the volume of cold water flow gradually decreasing until the flow is completely stopped. As described above, the transmission device of the present disclosure may enable the control and movements of an above-deck faucet handle to be translated to remotely control the operation of a below-deck valve cartridge.

In certain illustrative embodiment, the valve cartridge 114 may be a conventional cycling valve including features similar to those detailed in U.S. Pat. No. 5,725,010 to Marty et al. and U.S. Pat. No. 10,184,232 to Veros et al., the disclosures of which are expressly incorporated herein by reference. In other illustrative embodiments, the valve cartridge 114 may be of the type used in a two-handle faucet for controlling flow rate at a constant temperature, such as detailed in U.S. Pat. No. 8,881,755 to Thomas et al., the disclosure of which is expressly incorporated herein by reference.

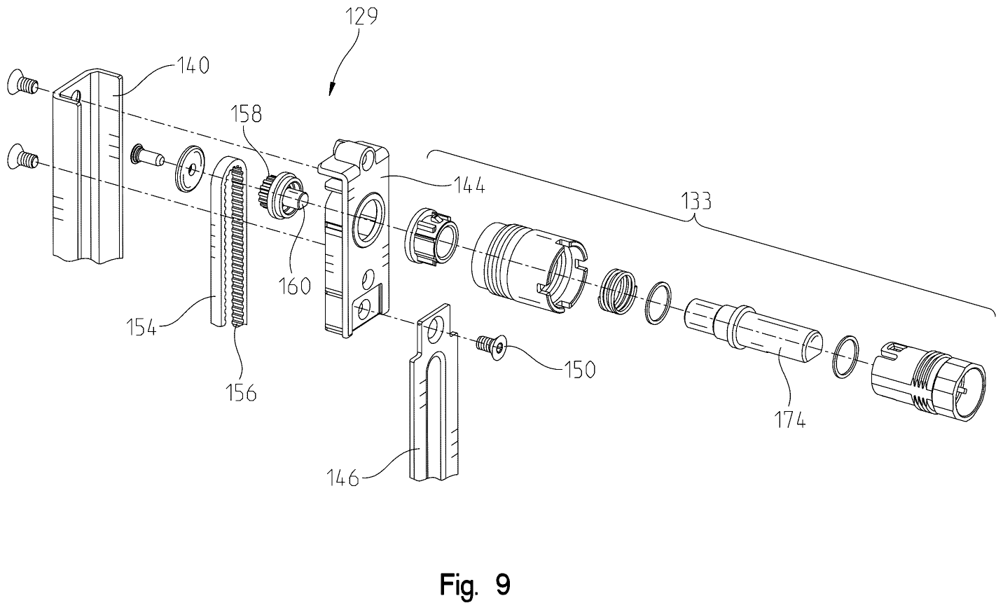

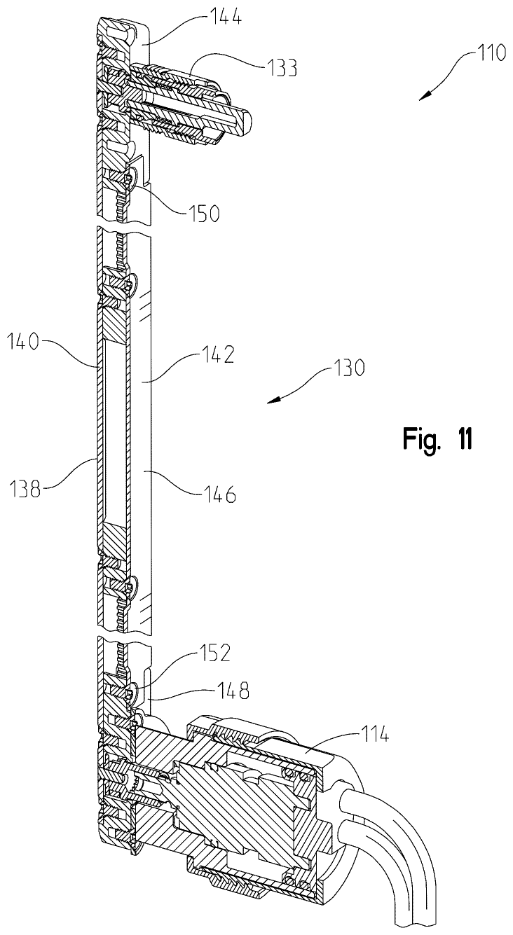

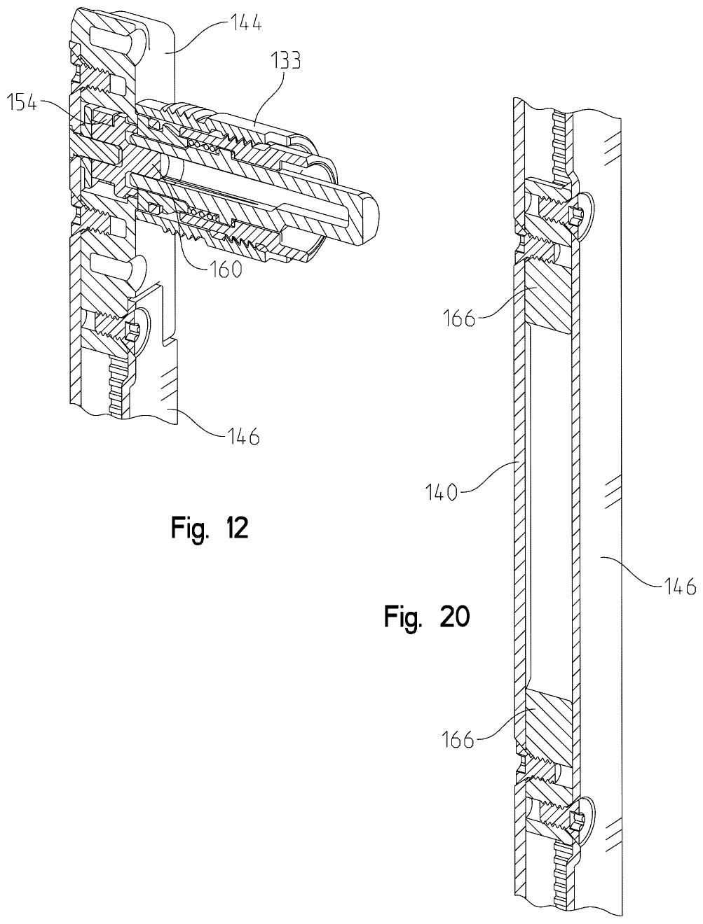

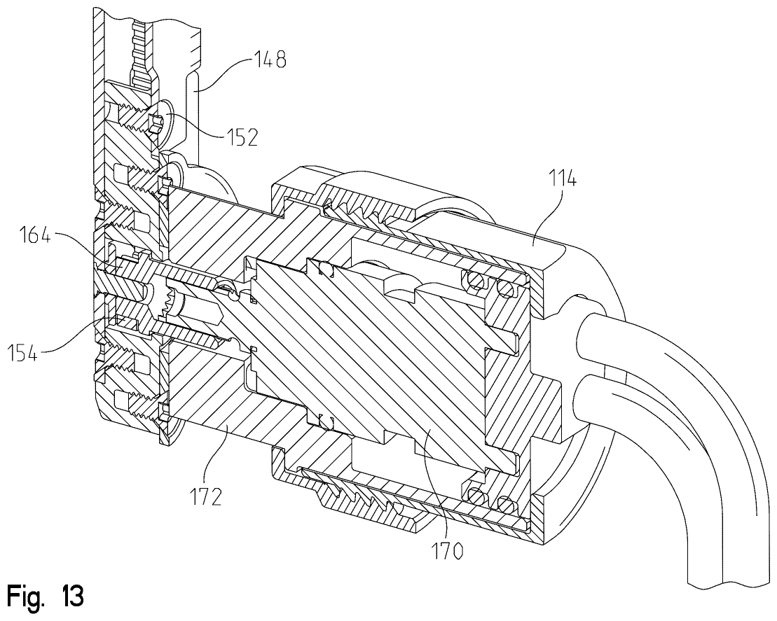

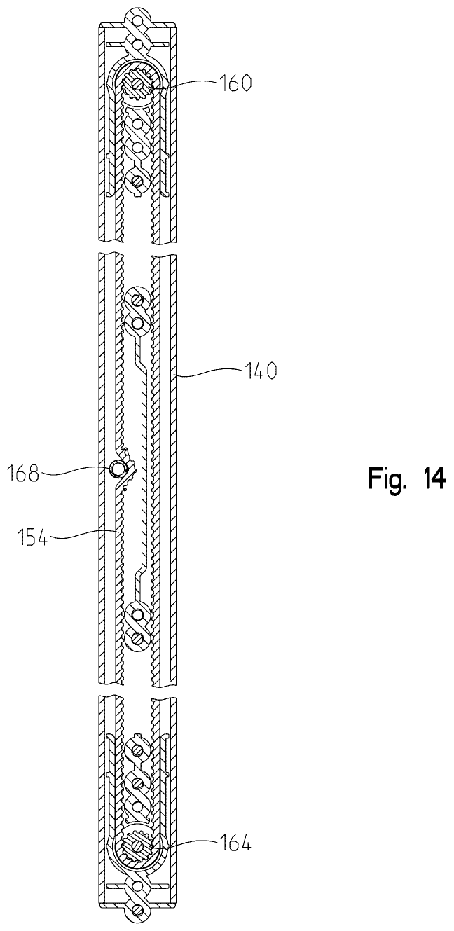

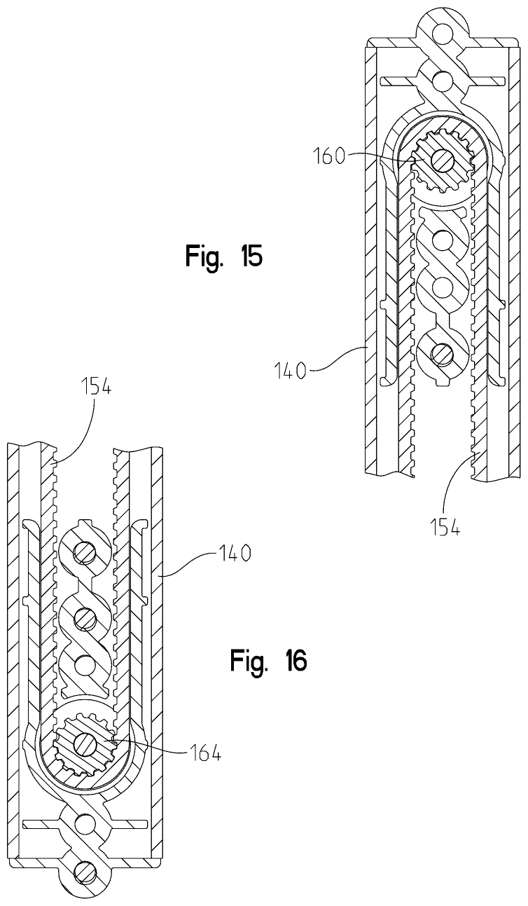

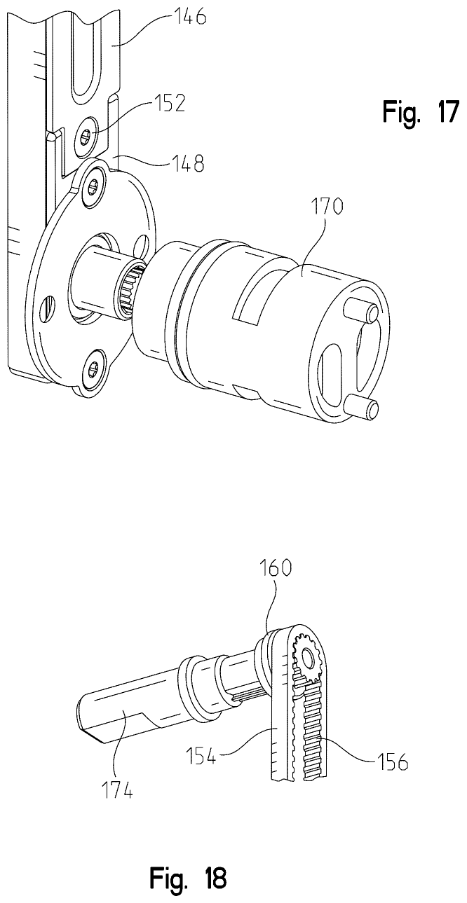

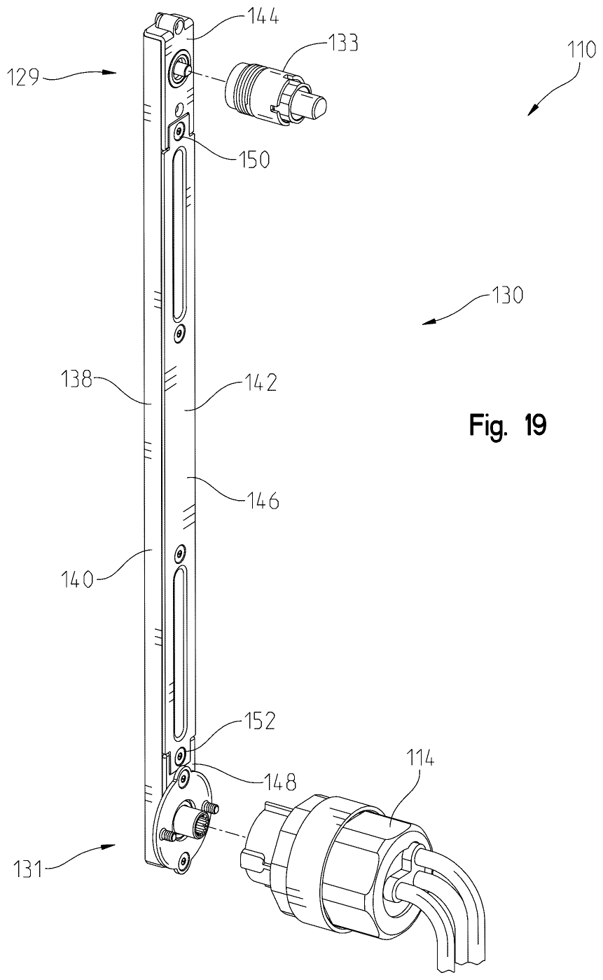

FIGS. 11-16 and 20 provide various cross-sectional views of illustrative valve assembly 110. FIGS. 17-19 illustrate the representative couplings between the belt gear coupler 160 and handle 112 and between the belt gear coupler 164 and valve cartridge 114. FIG. 17 illustrates a core 170 of valve cartridge 114 that is inside a housing 172 (FIG. 13) of valve cartridge 114. FIG. 18 illustrates a spindle 174 of controller 133. Spindle 174 is also shown in FIGS. 8-9.

Upper gear coupler 160 and lower gear coupler 164 are both shown as having teeth that mesh with the teeth of belt 154. However, it is to be understood that it is possible for there to be no teeth on either of the gear couplers or on the belt. For example, the invention may be implemented using toothless pulleys that turn with a toothless belt.

A power transmission element in the form of a belt has been described as transmitting power from upper gear coupler 160 to lower gear coupler 164. However, it is also possible within the scope of the invention to use another type of power transmission element, such as a chain.

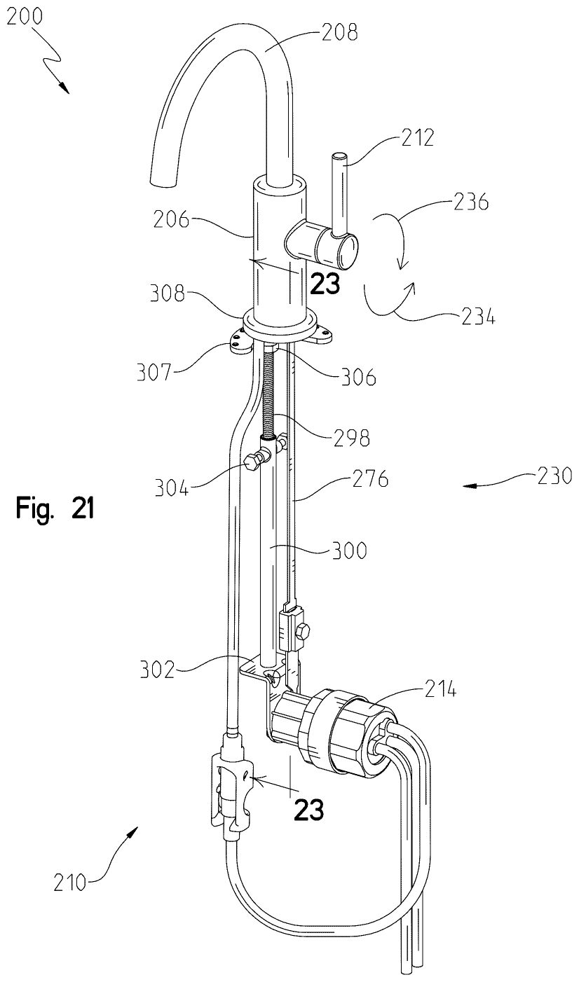

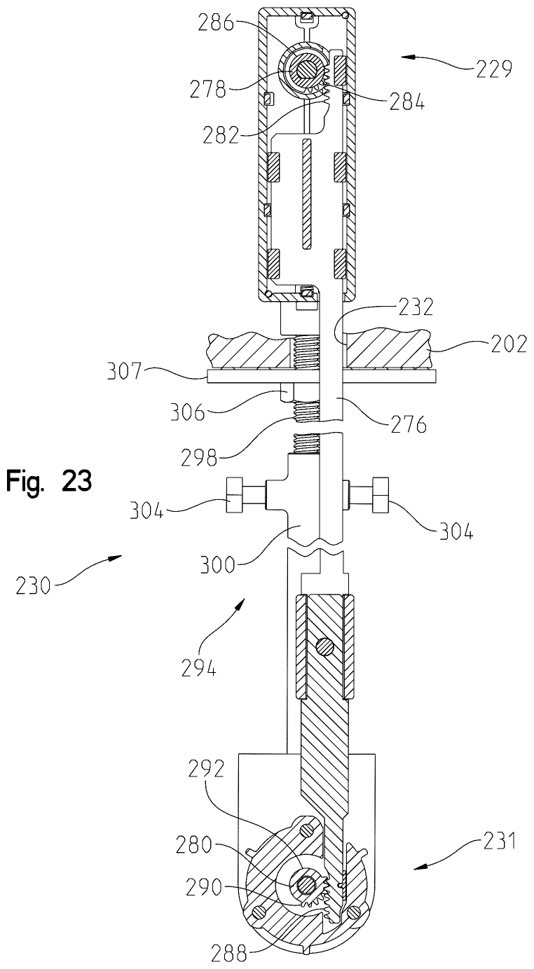

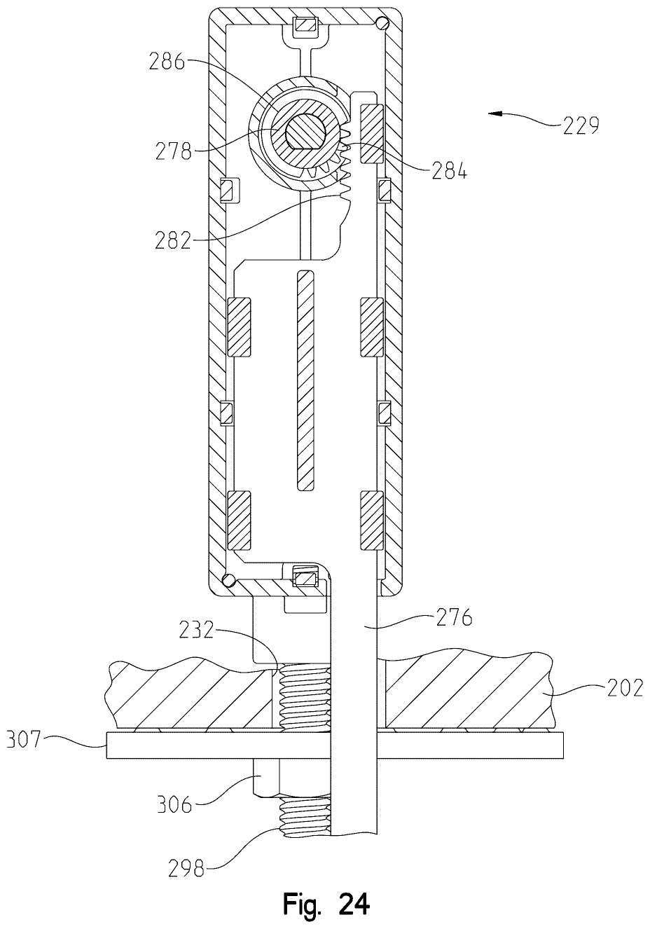

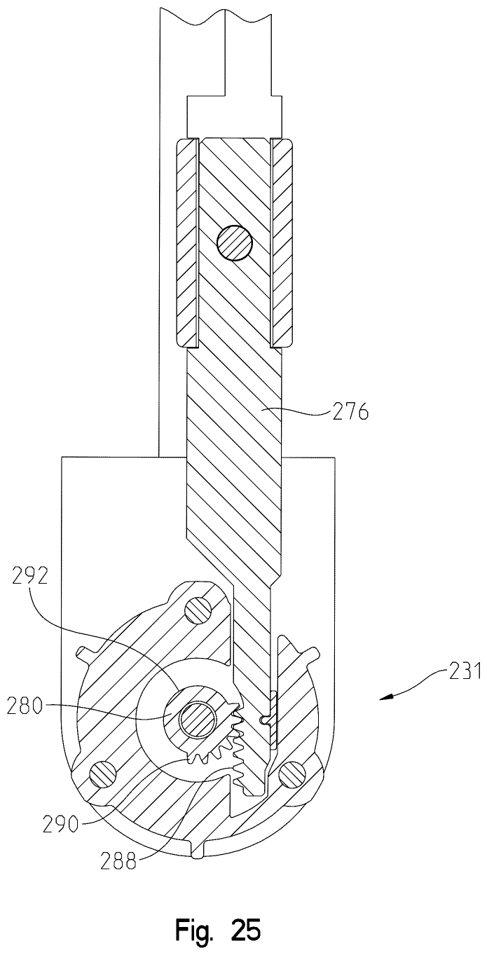

Illustrated in FIGS. 21-25 is another illustrative embodiment of the present disclosure in which a faucet assembly 200 includes a valve assembly 210 having a rack and pinion assembly 230 instead of a belt and gear assembly. Rack and pinion assembly 230 is coupled to handle 212 at its upper end 229, and is coupled to valve cartridge 214 at its lower end 231. Belt and gear assembly 230 can extend through a through-hole 232 (FIGS. 23-24) or other type of passageway or pass-through in mounting deck 202.

Lower end 231 of rack and pinion assembly 230 is coupled to valve cartridge 214. Upper end 229 of rack and pinion assembly 230 is coupled to a valve cartridge controller 233, which, in turn, is coupled to handle 212.

During use, as handle 212 is manually rotated in counterclockwise direction 234 (FIG. 21), controller 233 also rotates in counterclockwise direction 234. Similarly, as handle 212 is manually rotated in clockwise direction 236 (FIG. 21), controller 233 also rotates in clockwise direction 236.

Rack and pinion assembly 230 illustratively includes a rack 276 engaging an upper rotatable pinion 278 and a lower rotatable pinion 280. Upper pinion 278 is coupled to controller 233. Lower pinion 280 is coupled to valve cartridge 214. Rack 276 includes an upper set of linearly-arranged teeth 282 that engages an external set of teeth 284 (FIG. 23) on upper pinion 278. Teeth 284 are formed in an arcuate pattern on a circular periphery 286 of upper pinion 278. Rack 276 also includes a lower set of linearly-arranged teeth 288 that engages an external set of teeth 290 on lower pinion 280. Teeth 290 are formed in an arcuate pattern on a circular periphery 292 of lower pinion 280.

The vertical distance between controller 233 and valve cartridge 214 may be set and established by a height of a spine 294 including an upper bracket 296, a threaded shank 298, a pipe 300 and a lower bracket 302. A selected length of a threaded mounting shank 298 may be inserted into pipe 300 and locked therein by opposing bolts 304. As shown in FIG. 23, a mounting nut 306 may threadably engage mounting shank 298 and be tightened against a bottom side of mounting deck 202 via a mounting plate or washer 307. A base or escutcheon 308 (FIG. 21) supporting a faucet hub 206 may engage a top side of mounting deck 202 such that mounting deck 202 is clamped between base 308 and nut 306.

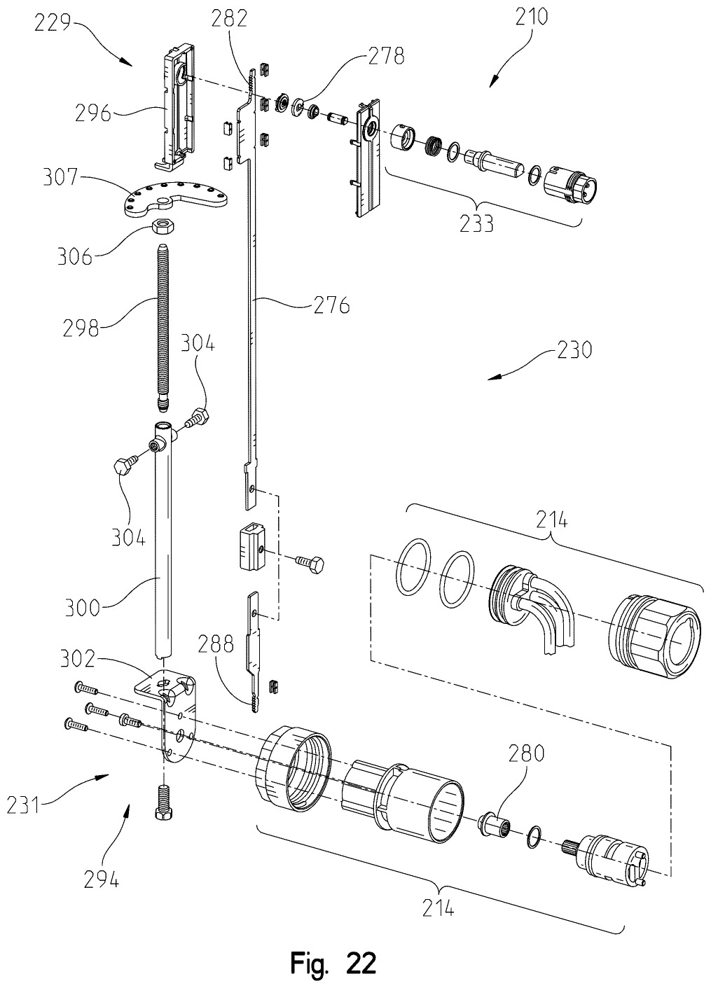

During operation, a human user may rotate handle 212 in counterclockwise direction 234, which causes controller 233 (FIG. 22) and upper pinion 278 to also rotate in counterclockwise direction 234. The intermeshing of teeth 284 of upper pinion 278 with teeth 282 of rack 276 causes the rotation of upper pinion 278 in direction 234 to result in a corresponding upward movement of rack 276. Further, the intermeshing of teeth 282 of rack 276 with teeth 290 of lower pinion 280 causes the upward movement of rack 276 to result in a corresponding rotation of lower pinion 280. Further still, the rotation of lower pinion 280 causes a corresponding rotation of valve cartridge 214.

Rotation of valve cartridge 214 may cause water to flow to spout 208 in the same manner as rotation of a conventional valve cartridge that is disposed above the sink deck would. In a particular embodiment, rotation of handle 212 in counterclockwise direction 234 initially causes only cold water to flow through spout 208 at an increasing rate until a maximum flow rate is reached. Further rotation of handle 212 after the maximum flow rate of cold water is reached results in the cold water gradually being replaced by hot water until the flow is comprised of hot water only. FIGS. 23-25 illustrate the valve cartridge 214 in an off position. In the illustrative embodiment, rotation of handle 212 counterclockwise by approximately 90 degrees causes corresponding rotation of upper pinion 278 and lower pinion 280 (via linear upward movement of rack 276), thereby causing rotation of the stem and valve member of the valve cartridge 214 to the full on position.

Rotation of handle 212 back in the opposite direction 236 may reverse the above-described progression, resulting in the hot water gradually being replaced by cold water, and then the volume of cold water flow gradually decreasing until the flow is completely stopped. Valve cartridge 214 may be similar to valve cartridge 114 further detailed above. As described above, the transmission device of the present disclosure may enable the control and movements of an above-deck faucet handle to be translated to remotely control the operation of a below-deck valve cartridge.

Other features of faucet assembly 200 may be similar to those of faucet assembly 100, and thus are not shown or described in detail herein in order to avoid needless repetition.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A faucet assembly configured to be mounted to a mounting deck having a passageway extending from a first surface of the mounting deck to a second surface of the mounting deck, the faucet assembly comprising:
a spout configured to emit a fluid therefrom;
a valve cartridge configured to be mounted below the mounting deck, the valve cartridge being configured to be connected to a source of the fluid and to provide the fluid to the spout, the valve cartridge having a plurality of rotational positions, a parameter of the fluid emitted by the spout being dependent upon a current said rotational position of the valve cartridge;
a lower wheel attached to the valve cartridge such that rotation of the valve cartridge follows rotation of the lower wheel;
a rotatable, manually-operable valve controller configured to be mounted above the mounting deck;
an upper wheel attached to the valve controller such that rotation of the upper wheel follows rotation of the valve controller; and
a belt configured to extend through the passageway of the mounting deck, the belt being carried by the lower wheel and by the upper wheel such that rotation of the upper wheel causes rotation of the belt, and the rotation of the belt causes rotation of the lower wheel.

2. The faucet assembly of claim 1 wherein the parameter of the fluid comprises a rate of flow of the fluid.

3. The faucet assembly of claim 1 wherein the parameter of the fluid comprises a temperature of the fluid.

4. The faucet assembly of claim 1 wherein the lower wheel comprises a lower gear having a periphery with teeth thereon, the upper wheel comprising an upper gear having a periphery with teeth thereon, the belt having internally-facing teeth intermeshed with the teeth of the lower gear and of the upper gear.

5. The faucet assembly of claim 1 further comprising a handle fixedly attached to the rotatable, manually-operable valve controller.

6. The faucet assembly of claim 1 further comprising a tensioner biased against the belt.

7. A faucet assembly, comprising:
a spout configured to emit a fluid therefrom;
a valve cartridge configured to be connected to a source of the fluid and to provide the fluid to the spout, the valve cartridge having a plurality of rotational positions, a parameter of the fluid emitted by the spout being dependent upon a current said rotational position of the valve cartridge;
a first wheel attached to the valve cartridge such that rotation of the valve cartridge follows rotation of the first wheel;
a rotatable, manually-operable valve controller;
a second wheel attached to the valve controller such that rotation of the second wheel follows rotation of the valve controller; and
a power transmission element engaging the first wheel and the second wheel such that rotation of the second wheel causes movement of the power transmission element, and the movement of the power transmission element causes rotation of the first wheel.

8. The faucet assembly of claim 7 wherein the first wheel comprises an upper gear, the second wheel comprises a lower gear, and the power transmission element comprises a belt.

9. The faucet assembly of claim 7, wherein the first wheel comprises an upper pinion, the second wheel comprises a lower pinion, and the power transmission element comprises a rack.

10. The faucet assembly of claim 7 wherein the power transmission element is configured to extend through a passageway in a mounting deck.

11. The faucet assembly of claim 7 wherein the parameter of the fluid comprises a rate of flow of the fluid.

12. The faucet assembly of claim 7 wherein the parameter of the fluid comprises a temperature of the fluid.

13. The faucet assembly of claim 7 wherein the first wheel comprises a lower gear having a periphery with teeth thereon, the second wheel comprising an upper gear having a periphery with teeth thereon, the power transmission element having internally-facing teeth intermeshed with the teeth of the lower gear and of the upper gear.

14. The faucet assembly of claim 7 further comprising a handle fixedly attached to the rotatable, manually-operable valve controller.

15. A faucet assembly configured to be mounted to a mounting deck having a passageway extending from a first surface of the mounting deck to a second surface of the mounting deck, the faucet assembly comprising:
a spout configured to emit a fluid therefrom;
a valve cartridge configured to be mounted below the mounting deck, the valve cartridge being configured to be connected to a source of the fluid and to provide the fluid to the spout, the valve cartridge having a plurality of rotational positions, at least one parameter of the fluid emitted by the spout being dependent upon a current said rotational position of the valve cartridge;
a lower pinion attached to the valve cartridge such that rotation of the valve cartridge follows rotation of the lower pinion, the lower pinion having a plurality of teeth;
a rotatable, manually-operable valve controller configured to be mounted above the mounting deck;
an upper pinion attached to the valve controller such that rotation of the upper pinion follows rotation of the valve controller, the upper pinion having a plurality of teeth; and
a rack configured to extend through the passageway of the mounting deck, the rack having an upper set of teeth and a lower set of teeth, the upper set of teeth being intermeshed with the teeth of the upper pinion, the lower set of teeth being intermeshed with the teeth of the lower pinion, rotation of the upper pinion causing vertical movement of the rack, and the vertical movement of the rack causing rotation of the lower pinion.

16. The faucet assembly of claim 15, wherein the at least one parameter of the fluid comprises a rate of flow of the fluid.

17. The faucet assembly of claim 15, wherein the at least one parameter of the fluid comprises a temperature of the fluid.

18. The faucet assembly of claim 15, wherein the at least one parameter of the fluid comprises a rate of flow of the fluid and a temperature of the fluid.

19. The faucet assembly of claim 15, wherein the upper set of teeth of the rack are arranged linearly, and the lower set of teeth of the rack are arranged linearly.

20. The faucet assembly of claim 15, further comprising a handle fixedly attached to the rotatable, manually-operable valve controller.
